(19) United States
(12) Patent Application Publication
(10) Pub. No.: US 2016/0110389 A1
(43) Pub. Date: Apr. 21, 2016

(54) Semantic Database Platform

(71) Applicant: PERVASIVE HEALTH INC., Chicago, IL (US)

(72) Inventors: Michael OLTMAN, Oak Park, IL (US); Aaron SYMANSKI, Chicago, IL (US)

(21) Appl. No.: 14/894,278

(22) PCT Filed: May 28, 2014
(86) PCT No.: PCT/US2014/039776

§ 371 Date: Nov. 25, 2015

Related U.S. Application Data
(60) Provisional application No. 61/828,047, filed on May 28, 2013.

(51) Int. Cl. G06F 17/30

(52) U.S. Cl. CPC G06F 17/30312; G06F 17/30923

(57) ABSTRACT

A semantic database platform may include an interface through which a user may provide data in a form selected by the user and a database that stores the data in the form selected by the user. The data may be organized into events, each of which includes one or more facts, each of which facts may include a value and an indication vocabulary of which the value is a member. The user may select the vocabulary. The database may store the data in the form in which it is presented by the user.

### CROSS-REFERENCE TO RELATED APPLICATION

This application claims the benefit of U.S. provisional application No. 61/828,047, filed May 28, 2013, now pending.

### BACKGROUND

a. Technical Field

The instant disclosure relates to the storage of data in a database, including the form and structure used to store such data.

b. Background Art

In known database systems, the types and format of data that may be input by a user are generally constrained by the types and format of data expected by the database. For example, a database may consist of a plurality of data fields, each having an expected data type (e.g., integer, string, etc.), an expected information type represented by the data (e.g., in a medical database, one field may contain data representing a patient's height, another field the patient's weight, and yet another field representing the patient's cholesterol), and an expected unit for the data (following the patient example, the units for the above information may be inches, pounds, and mg/dL, respectively). A user may be required to enter data in a form, structure, and of a type dictated by the configuration of the database.

Other known database systems may provide an interface that appears to allow a user to define the form, structure, or type of data entered. However, the database may still store the data in a predetermined format.

### SUMMARY

By requiring that data conform to an expected data type, information type, and structure, known database systems are restricted in their ability to dynamically adapt to new types of data that a user may want to add to the database. Users of such databases may be equally restricted in their ability to store and retrieve data in a preferred format. Such restrictions may be especially problematic in the medical industry, in which different care providers often define their data according to different ontologies. Accordingly, a method for storing data in a database that improves on known database systems may comprise providing a computer-based interface through which a user may enter data comprising one or more events, each of the events comprising one or more facts. Each fact may comprise a value and an indication of the vocabulary of which the value is a member, the vocabulary selected by the user from among a set of possible vocabularies. The method may further include receiving the one or more events at the database and causing the one or more events, facts, values, and indications of the vocabulary of which the values are members to be stored in the database.

A system that improves on known database systems may include an electronic control unit (ECU) configured to provide an interface through which a user may enter data comprising one or more events, each of the events comprising one or more facts, each fact comprising a value and an indication of the vocabulary of which the value is a member. The system may further include a database configured to receive the one or more events entered by the user and store the one or more events, each event comprising the one or more facts, each fact comprising the value and the indication of the vocabulary of which the value is a member.

### BRIEF DESCRIPTION OF THE DRAWINGS

FIG. 1 is a block diagram view of an exemplary database system.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

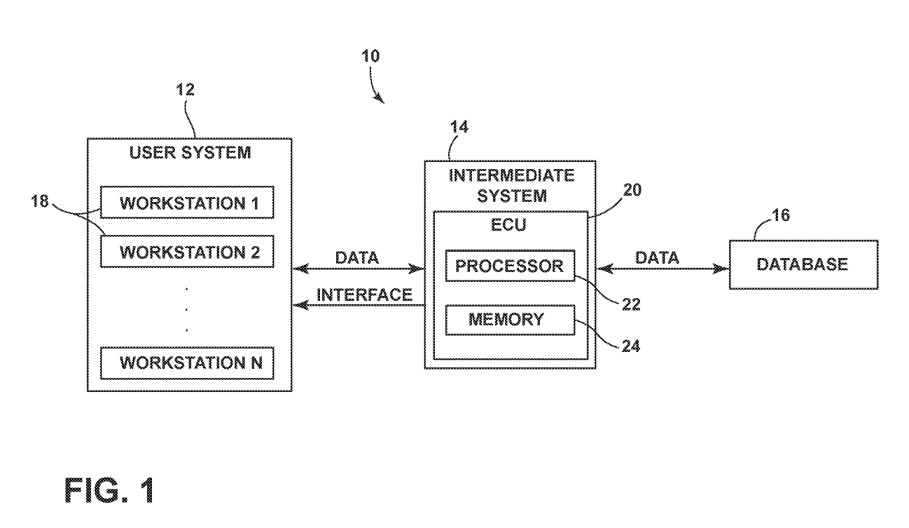

Referring to the FIGURES, in which like reference numerals reference identical or similar components in the various views, FIG. 1 is a block diagram view of an exemplary database system 10. The database system 10 may include a user system 12, an intermediate system 14, and a database 16. A purpose of the system 10, among other purposes, may be to allow one or more users of the user system 12 to store data in the database 16 and retrieve data from the database 16. In an embodiment, the system 10 may be configured for the storage and retrieval of medical data, though the system 10 may also find use in other fields. Accordingly, although the system 10 may be described herein with reference to examples from the medical field, neither the system 10 nor the components or functions of the system 10 are limited to use in the medical field. Rather, the system 10, the functions and components of the system 10, and the concepts described with reference to the system 10 may find use in a wide variety of applications and fields.

The user system 12 may comprise a number of workstations 18, in an embodiment (for visual clarity, not all workstations 18 are designated in FIG. 1). In an exemplary embodiment, the user system 12 may be located in a hospital or clinic, and each of the user workstations 18 may be located in a respective examination room. Each workstation 18 may be configured to access an interface for loading data to the database 16, in an embodiment, which interface may be accessible as a program installed on the user workstation 18 or on a network of the user system 12, may be provided as a world wide web interface, or may be provided through other means known in the art. Accordingly, each workstation 18 may be configured for internet access, in an embodiment.

The database 16 may be provided as a repository of data. The database may be a modern document store that supports array fields, searching on the stored arrays, and multi-key indexes, in an embodiment. The database may be configured to accept XML documents, JSON documents, and/or modified JSON documents, in an embodiment. For example, the database 16 may be based on the MongoDB system commercially available from 10gen, Inc. of New York City, N.Y. In an embodiment, the database 16 may store data provided by the user system 12 and by other systems. In such an embodiment, a user of the user system 12 may have access to the data stored on the database 16 provided by the user system 12 and by other systems.

The intermediate system 14 may include an electronic control unit (ECU) 20, which ECU 20 may comprise a processor 22 and a memory 24. The memory 24 may store instructions, and the processor 22 may be configured to execute those instructions to perform one or more tasks or operations described above and/or below.

The intermediate system 14 may be configured to provide an interface to the user system 12 for, among other things, loading data into the database 16. The intermediate system 14 may be configured to provide the interface through the world wide web, in an embodiment. In such an embodiment, the user system 12 may not need to have any program (other than a web browser) installed on the workstations 18 in order to utilize the database.

The intermediate system 14 may be further configured to cause data provided by the user system 12 to be stored in the database 16. Accordingly, the intermediate system 14 may be configured to receive data from the user system 12 and to pass the data along to the database 16. Alternatively, the intermediate system 14 may be configured to assist in establishing a “direct” connection (i.e., a connection that does not involve transmitting the data to or through the intermediate system 14) between the user system 12 and the database 16.

In embodiments, the intermediate system 14, one or more components of the intermediate system 14, and/or functions of the intermediate system 14 may be implemented in the database 16, in the user system 12, or partially in the database 16 and partially in the user system 12. Accordingly, the discussion and illustration herein of the intermediate system 14 as a separate system should be understood as an embodiment, and not as a requirement of the system 10.

The interface and the database 16 may improve on data loading systems and database platforms known in the art. The data structure in the database 16, as described below, may allow the user system 12 to define the types of information stored in the database 16 according to the user's own semantic vocabulary or ontology. The interface may also be structured and presented to accept data according to the user's own semantic vocabulary or ontology. Because the system 10 may be configured to accept, store, and allow users to work with data as defined by the user's own semantic ontology, the system 10 may be considered to provide a fully semantic database platform.

As used herein, a vocabulary or ontology may refer to a set of codes or terms, each of which represents a respective set of one or more values, concepts, etc. For example, in a medical application, ICD-9, ICD-10, and SNOMED-CT are known vocabularies. Each code within a medical vocabulary may represent, for example, one or more diseases, signs, symptoms, conditions, causes of injury or disease, treatments, entities (e.g., an organism or structure or component of the organism), events, objects, and/or other information relevant to a health condition or patient. The instant disclosure, however, is not limited to only those vocabularies explicitly named herein or to medical applications.

The database 16 may be configured to store, and the interface may be configured to accept, data on an event-by-event basis. For example, but without limitation, a visit to a medical clinic or hospital for a routine check-up or operation could result in multiple medical events, each event representing an activity during the visit. Each event may comprise a date and time and one or more data types, such as facts, actors, diagnoses, and observations, each of which may comprise one or more of a value, a code system, a code, a descriptor of the value, and a unit of the value. For a given event, the database 16 may store as many facts and other data as may be desired by the user. In an embodiment, events and facts may further comprise additional components for administrative or other purposes.

Allowing the user to specify a code system and/or unit at the time of loading data to the database 16 allows the user to define the format and contents of the data according to the semantic vocabulary or ontology preferred by the user instead of requiring the user to match the form expected or required by the database. Additionally, because the database 16 may store the data substantially in the form provided by the user (i.e., without conversion to a single consistent format, vocabulary, or ontology that the database is programmed to accept), storage operations by the database 16 may simplified. For the same reason, the user's access to the user's data, in the format preferred by the user, is also simplified.

As noted above, traditional database systems require that data be presented by a user and/or stored in a database in a pre-defined form (i.e., according to pre-defined data types, structures, and information types). In contrast, in the semantic platform described herein, the user may define the structure of the data according to the code system, units, and other aspects selected for a given piece of data. For example, some known database systems may require that a medical patient's height be entered in a particular unit (e.g., inches). In other known database systems, a user may be permitted to enter the patient's height in any desired unit, but the database may convert the height to a desired unit so that all heights are stored in the same units. In contrast, in the semantic platform according to the present disclosure, the patient's height may be entered in any unit (e.g., inches, meters), and stored in the database in whatever units the user provided. Any needed conversion of data may be performed when needed according to a mapping of different data types, as further described below. The database 16 may similarly accept and store diagnoses and other data in a user's desired ontology Thus, the user may still access its own data in its preferred form, but the data may be usable by users and algorithms contemplating different ontologies.

In another example, a first patient may be diagnosed with a particular condition during a clinic visit. The clinic may classify the condition according to a particular medical ontology, such as ICD-9, for example only. The user (e.g., clinician) may enter the visit as an event and the diagnosis as a piece of data within the event, along with other relevant data from the visit (e.g., height, weight, other diagnoses, orders, etc.). The clinician may enter the diagnosis using the ICD-9 code as the code, ICD-9 as the code set, and the diagnosis name as the value. The patient's height may also be recorded as part of the event. The patient's height may be entered according to the LOINC ontology, which may require the measurement in inches. When the data is stored into the semantic database 16, it may be stored with the code system LOINC, the LOINC height code, the height measurement in inches as the value, and the unit of “in.” The event may be stored in the database 16 as entered by the clinician (i.e., using the ICD-9 code and including the code set). Thus, the clinic may continue to retrieve the event and the relevant data of the event from the database 16 in the ontology used for each piece of relevant data (i.e., ICD-9 for the diagnosis, LOINC for height) without conversion by the database 16 or by the clinic.

In another clinic, a second patient may also be diagnosed with the same condition, but the clinic may use SNOMED-CT as its medical ontology. Accordingly, the clinic may enter the visit as an event and the diagnosis as a piece of data within the event, classified according to SNOMED-CT. The database 16 may store the event as entered by the clinician (i.e., with SNOMED-CT codes). Thus, the clinic may continue to retrieve the event and the facts of the event from the database 16 in SNOMED-CT codes without conversion by the database 16 or the clinic. Thus, the database 16 may store data according to ICD-9, ICD-10, SNOMED-CT, a custom medical ontology, or any ontology or vocabulary in any field. Further, as shown by the example above, different data sets within the database 16 may be stored according to different ontologies.

Loading data to the database 16 may be performed using an application programming interface (API) that, as noted above, allows the user to define the structure and form of the data and the amount of data to be stored. Data loading may be based on loading XML or JSON (JavaScript Object Notation) documents through a REST (Representational State Transfer) interface. Each document loaded into the database 16 may be stored as the original binary document that was built by the user through the data load interface. The API may be based on a programming language such as Python, in an embodiment. An exemplary XML data loading API for medical data is shown in Table 1 below, along with explanatory comments.

TABLE 1

| API | Comment |
|---|---|
| <apertiva> | |
| <event> | |
| <observationdatetime/> | Date and time of event |
| <eventid>/> | Unique identifier for the event |
| | (Optional) |
| <sourceid/> | The “subject” identity in the feeding |
| | source system. |
| <sourceidtype/> | The type of source id (Optional) |
| <sourcesystem/> | |
| <eventdatetimes> | |
| <duration> | |
| <startdatetime/> | If provided, should match the |
| <enddatetime/> | observationdatetime |
| <expectedenddatetime /> | |
| </duration> | |
| <validity> | |
| <startdatetime/> | Valid start datetime |
| <enddatetime/> | Valid end datetime |
| </validity> | |
| <system> | System datetime when the event was |
| <createdatetime/> | recorded |
| <modifydatetime/> | |
| </system> | |
| <custom> | |
| <datetimetype/> | |
| <datetime/> | |
| </custom> | |
| </eventdatetimes> | |
| <altidentifiers> | Allows multiple identifiers from |
| <identifier> | multiple systems for cross |
| <sourcesystem/ | referencing. For organizations |
| <sourceidtype/> | where data may come from multiple |
| <sourceid/> | sources with multiple identifiers for |
| | the same subject. |
| </identifier> | |
| </altidentifiers> | |
| <eventgroups> | Specifies groupings for which events |
| <eventgroup> | are related to each other. |
| <grouptype/> | Defines the group type., e.g., |
| <groupid/> | Encounter Group identifier. |
| </eventgroup> | |
| </eventgroups> | |
| <actors> | |
| <actor> | |
| <codesystem/> | Vocabulary/ontology system name |
| <code/> | Vocabulary code |
| <value/> | |
| </actor> | |
| </actors> | |
| <diagnoses> | |
| <diagnosis> | |
| <codesystem/> | |
| <code/> | |
| <value/> | |
| </diagnosis> | |
| </diagnoses> | |
| <facts> | |
| <fact> | |
| <codesystem/> | |
| <code/> | |
| <value/> | |
| <unit/> | |
| </fact> | |
| </facts> | |
| <observations> | |
| <observation> | |
| <codesystem/> | |
| <code/> | |
| <value/> | |
| <unit/> | |
| </observation> | |
| </observations> | |
| <locations> | |
| <location> | |
| <codesystem/> | |
| <code/> | |
| <value/> | |
| </location> | |
| </locations> | |
| <orders> | |
| <order> | |
| <codesystem/> | |
| <code/> | |
| <value/> | |
| <unit/> | |
| </order> | |
| </orders> | |
| </event> | |
| <event> | Multiple events can be loaded for |
| . | multiple subjects in a single XML |
| . | document |
| . | |
| </event> | |
| . | |
| . | |
| . | |
| </apertiva> | |

In the apertiva API, an “event” may be a container for information curated and related to the recording of information in a single health record event (e.g., a diagnosis, measurement, or triage examination). The “code system” refers to the vocabulary or ontology (e.g., in a medical application, ICD-9, ICD-10, SNOMED-CT) for which a code is provided to identify the type of data recorded. The “code” may be the specific identifier in the code system provided. The “unit” may be the unit or type of value provided (e.g., cm, mmHg, g/dL, datetime, int, string). “Source system,” “source id,” and “source id type” may refer to the origin point of the data, the subject within that origin, and the identifier type, respectively. “Event groups” may be common types of events (e.g., in a medical context, visit, encounter, episode, etc.). “Actors” may be persons involved in an event other than the subject of the event (e.g., where a patient is the subject, actors may be physicians, clinicians, nurses, etc.). “Locations” may be locations where the event took place or where the event data was recorded. “Orders” may be actions that are ordered during or as a result of the event, and “observations” may be data points about the subject, which data points may be the result of orders. “Facts” may be other types of data that do not easily fit into one of the above categories.

Within most of the above data types (code, unit, event groups, actors, facts, etc.), the form and vocabulary of data may be defined by the user according to a given codeset. The codeset may be a common codeset (in a medical application, ICD-9, ICD-10, SNOMED-CT, etc.), or may be a custom codeset. Accordingly, the semantic platform of the present disclosure permits a user of the system (e.g., a clinician) to input data in whatever form the user desires. Furthermore, in an embodiment, the platform may provide a smaller number of data types (e.g., just “facts”) and maintain the same functionality as the API shown in table 1.

It should be noted that the apertiva API illustrated in table 1 above is only exemplary in nature and should be understood to illustrate the semantic approach of this disclosure, but should not be understood to be limiting. The specific types of information contemplated by the API (e.g., diagnoses, locations, orders) may be altered for a desired application.

As noted above, XML documents may be used to load data using the semantic API of table 1. An exemplary schema that may be used for such an XML document is provided in Table 2.

```
TABLE 2
<xs:schema attributeFormDefault=“unqualified” elementFormDefault=“qualified”
xmlns:xs=“http://www.w3.org/2001/XMLSchema”>
  <xs:element name=“apertiva”>
    <xs:complexType>
      <xs:sequence>
        <xs:element name=“event”>
          <xs:complexType>
            <xs:sequence>
              <xs:element name=“header”>
                <xs:complexType>
                  <xs:sequence>
                    <xs:element type=“xs:string” name=“observationdatetime”/>
                    <xs:element type=“xs:string” name=“eventid”/>
                    <xs:element type=“xs:int” name=“sourceid”/>
                    <xs:element type=“xs:string” name=“sourceidtype”/>
                  </xs:sequence>
                </xs:complexType>
              </xs:element>
              <xs:element name=“times”>
                <xs:complexType>
                  <xs:sequence>
                    <xs:element name=“duration”>
                      <xs:complexType>
                        <xs:sequence>
                          <xs:element type=“xs:string” name=“startdatetime”/>
                          <xs:element type=“xs:string” name=“enddatetime”/>
                        </xs:sequence>
                      </xs:complexType>
                    </xs:element>
                    <xs:element name=“validity”>
                      <xs:complexType>
                        <xs:sequence>
                          <xs:element type=“xs:string” name=“startdatetime”/>
                          <xs:element type=“xs:string” name=“enddatetime”/>
                        </xs:sequence>
                      </xs:complexType>
                    </xs:element>
                    <xs:element type=“xs:string” name=“recordeddatetime”/>
                  </xs:sequence>
                </xs:complexType>
              </xs:element>
              <xs:element name=“altidentifiers”>
                <xs:complexType>
                  <xs:sequence>
                    <xs:element name=“identifier”>
                      <xs:complexType>
                        <xs:sequence>
                          <xs:element type=“xs:string” name=“sourcesystem”/>
                          <xs:element type=“xs:string” name=“sourceidtype”/>
                          <xs:element type=“xs:string” name=“sourceid”/>
                        </xs:sequence>
                      </xs:complexType>
                    </xs:element>
                  </xs:sequence>
                </xs:complexType>
              </xs:element>
              <xs:element name=“eventgroups”>
                <xs:complexType>
                  <xs:sequence>
                    <xs:element name=“group”>
                      <xs:complexType>
                        <xs:sequence>
                          <xs:element type=“xs:string” name=“grouptype”/>
                          <xs:element type=“xs:string” name=“groupid”/>
                        </xs:sequence>
                      </xs:complexType>
                    </xs:element>
                  </xs:sequence>
                </xs:complexType>
              </xs:element>
              <xs:element name=“actors”>
                <xs:annotation>
                  <xs:documentation>DATA</xs:documentation>
                </xs:annotation>
                <xs:complexType>
                  <xs:sequence>
                    <xs:element name=“actor”>
                      <xs:complexType>
                        <xs:sequence>
                          <xs:element type=“xs:string” name=“codesystem”/>
                          <xs:element type=“xs:string” name=“code”/>
                          <xs:element type=“xs:string” name=“value”/>
                        </xs:sequence>
                      </xs:complexType>
                    </xs:element>
                  </xs:sequence>
                </xs:complexType>
              </xs:element>
              <xs:element name=“diagnoses”>
                <xs:complexType>
                  <xs:sequence>
                    <xs:element name=“diagnosis”>
                      <xs:complexType>
                        <xs:sequence>
                          <xs:element type=“xs:string” name=“codesystem”/>
                          <xs:element type=“xs:string” name=“code”/>
                          <xs:element type=“xs:string” name=“value”/>
                        </xs:sequence>
                      </xs:complexType>
                    </xs:element>
                  </xs:sequence>
                </xs:complexType>
              </xs:element>
              <xs:element name=“records”>
                <xs:complexType>
                  <xs:sequence>
                    <xs:element name=“record”>
                      <xs:complexType>
                        <xs:sequence>
                          <xs:element type=“xs:string” name=“codesystem”/>
                          <xs:element type=“xs:string” name=“code”/>
                          <xs:element type=“xs:string” name=“value”/>
                          <xs:element type=“xs:string” name=“unit”/>
                        </xs:sequence>
                      </xs:complexType>
                    </xs:element>
                  </xs:sequence>
                </xs:complexType>
              </xs:element>
              <xs:element name=“observations”>
                <xs:complexType>
                  <xs:sequence>
                    <xs:element name=“observation”>
                      <xs:complexType>
                        <xs:sequence>
                          <xs:element type=“xs:string” name=“codesystem”/>
                          <xs:element type=“xs:string” name=“code”/>
                          <xs:element type=“xs:string” name=“value”/>
                          <xs:element type=“xs:string” name=“unit”/>
                        </xs:sequence>
                      </xs:complexType>
                    </xs:element>
                  </xs:sequence>
                </xs:complexType>
              </xs:element>
              <xs:element name=“locations”>
                <xs:complexType>
                  <xs:sequence>
                    <xs:element name=“location”>
                      <xs:complexType>
                        <xs:sequence>
                          <xs:element type=“xs:string” name=“codesystem”/>
                          <xs:element type=“xs:string” name=“code”/>
                          <xs:element type=“xs:string” name=“value”/>
                        </xs:sequence>
                      </xs:complexType>
                    </xs:element>
                  </xs:sequence>
                </xs:complexType>
              </xs:element>
              <xs:element name=“orders”>
                <xs:complexType>
                  <xs:sequence>
                    <xs:element name=“order”>
                      <xs:complexType>
                        <xs:sequence>
                          <xs:element type=“xs:string” name=“codesystem”/>
                          <xs:element type=“xs:string” name=“code”/>
                          <xs:element type=“xs:string” name=“value”/>
                          <xs:element type=“xs:string” name=“unit”/>
                        </xs:sequence>
                      </xs:complexType>
                    </xs:element>
                  </xs:sequence>
                </xs:complexType>
              </xs:element>
            </xs:sequence>
          </xs:complexType>
        </xs:element>
      </xs:sequence>
    </xs:complexType>
  </xs:element>
</xs:schema>
```

Some known databases which, as noted above, may accept data in different forms (i.e., may offer a semantic interface), but store data in a predetermined form (i.e., according to a single vocabulary). In other words, some known database systems may convert data to a single vocabulary or form at the time of storage. In contrast, the database 16 and the semantic platform of this disclosure may store data under a vocabulary and form defined by the user—i.e., a number of different vocabularies may be represented in the database 16. As a result, to perform operations on data within the database 16, conversion may be required. In an embodiment, each vocabulary or ontology may itself be stored in the database 16, and relationships (i.e., translations) between vocabularies or ontologies may be stored in one or more graphs in the database 16 or may be accessible to the database 16 or to users of the database 16. Accordingly, relationships between different vocabularies may be known by the database 16, by the intermediate system 14, and/or by the user system 12.

A set of basic functions may be established (e.g., within the intermediate system 14) for converting any given data type into a desired vocabulary or ontology. Such basic functions may invoke or rely on stored conversion graphs (i.e., translation one ontology or vocabulary to another), in an embodiment. For example, a “height” function may be established that retrieves a patient's height, and a “inch” function may be established that converts any given numerical value to inches. The height and inch functions may be chained together, in an embodiment, to retrieve a patient's height in inches. Accordingly, a higher-order function seeking a patient's height in inches may call the height function and the inch function (e.g., patient.height.inch, in an embodiment based on Python code) configured to retrieve a patient's height in inches, whether that height is stored in inches or any other unit. The higher-order function may never actually see the data as stored in the database 16. Similar functions (i.e., for conversion and retrieval, like “inch” and “height”) may exist for some or all data types (including, but not limited to, patient attributes, actors, diagnoses, etc.) that may exist on the database 16, as well as some or all units, ontologies, and vocabularies represented on the database. Such functions may be chained together, in an embodiment and as shown above (e.g., patient.height.inch) to provide data in a preferred format.

Functions operating on the data stored within the database 16 may be provided by a user, by the operator of the intermediate system 14, and/or by third parties, in an embodiment. In addition, a first user may invoke functions that operate on a second user's data, provided that permission is granted by the second user, or on public data on the database 16. As noted above, because unit, vocabulary, and ontology conversion functions may be readily available, a user may perform operations on data stored in a number of different formats, according to a number of different vocabularies, and obtain the results in the format and vocabulary preferred by the user. As a result, different users may interact with each other's data (e.g., share or combine data) without any need for either user to convert its own data to a format preferred by the other, and without any need for the database 16 itself to convert any of the data as-stored. By providing an interface and database 16 that accept and store data in a form defined by the user and only converting data when needed, the system 10 provides a fully semantic database platform that advantageously and simply allows users to store their data in their preferred form and to view any data in their preferred form.

Although a number of embodiments have been described above with a certain degree of particularity, those skilled in the art could make numerous alterations to the disclosed embodiments without departing from the sprit or scope of this disclosure. For example, all joinder referenced (e.g., attached, coupled, connected, and the like) are to be construed broadly and may include intermediate members between a connection of elements and relative movement between elements. As such, joined references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by referenced herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A method of storing data in a computer database, the method comprising:
providing a computer-based interface through which a user may enter data comprising one or more events, each of the events comprising one or more facts, each fact comprising a value and an indication of the vocabulary of which the value is a member, the vocabulary selected by the user from among a set of possible vocabularies;
receiving the one or more events at the database; and
causing the one or more events, facts, values, and indications of the vocabulary of which the values are members to be stored in the database.

2. The method of claim 1, wherein each fact further comprises an indication of the unit of the value, wherein the unit is dictated by the user.

3. The method of claim 1, wherein the database receives the one or more records in XML format.

4. The method of claim 1, wherein each event further comprises a date and time.

5. A system, comprising:
an electronic control unit (ECU) configured to provide an interface through which a user may enter data comprising one or more events, each of the events comprising one or more facts, each fact comprising a value and an indication of the vocabulary of which the value is a member; and
a database configured to receive the one or more events entered by the user and store the one or more events, each event comprising the one or more facts, each fact comprising the value and the indication of the vocabulary of which the value is a member.

6. The system of claim 5, wherein the ECU is configured to provide the interface through the internet.
